(19) United States
(12) Patent Application Publication
(10) Pub. No.: US 2025/0089738 A1
(43) Pub. Date: Mar. 20, 2025

(54) SYSTEMS AND METHODS FOR PROCESSING SOYBEANS

(71) Applicant: Ace Ethanol, LLC, Stanley, WI (US)

(72) Inventors: Joseph Fischer, Eau Claire, WI (US); Colton Walz, Elk Mound, WI (US); Neal Kemmet, Eau Claire, WI (US); Eileen Goss, Eau Claire, WI (US); Shannon Steinmetz, Chippewa Falls, WI (US); Matthew Drilling, Stanley, WI (US)

(21) Appl. No.: 18/889,644

(22) Filed: Sep. 19, 2024

Related U.S. Application Data
(60) Provisional application No. 63/583,668, filed on Sep. 19, 2023.

(51) Int. Cl. A23J 1/14; A23L 11/00; A23L 11/30; A23L 11/50

(52) U.S. Cl. CPC A23J 1/148; A23L 11/07; A23L 11/30; A23L 11/50

(57) ABSTRACT

Exemplary methods and systems process either (i) raw whole soybeans and/or roasted soybeans, or (ii) soybean meal. Feedstock size is reduced, oil may be removed, and a slurry is generated. The slurry is heated and cooked and, after cooling the cooked slurry, enzymatic hydrolysis and saccharification are initiated. A resulting soybean mash may be combined with yeast to generate soybean beer. Ethanol is removed from the soybean beer and a high protein stillage may be recovered. Oil may be removed from the high protein stillage, and the de-oiled high protein stillage may be further concentrated and/or dried.

### CROSS-REFERENCE TO RELATED APPLICATION(S)

This application claims priority to U.S. Provisional Patent Application No. 63/583,668 filed on Sep. 19, 2023, the entire contents of which is hereby incorporated by reference.

### FIELD

The present disclosure relates to systems, methods and techniques for processing soybeans. Exemplary systems, methods, and techniques may generate a high protein product.

### INTRODUCTION

Whole soybeans include a hull portion and soybean seeds within the hull portion. Soybean seeds are a popular plant-based protein source. Soybeans have also been used for the production of ethanol.

### SUMMARY

In some aspects, the techniques described herein relate to a method for processing soybean material, the method including: receiving feedstock including either (i) raw whole soybeans and/or roasted soybeans, or (ii) soybean meal; when the feedstock includes (i), reducing a size of the feedstock via pressing, hammermilling or roller-milling thereby generating processed soybeans; when the feedstock includes more than 12 wt % oil dry basis, removing a portion of a raw bean oil from the processed soybeans to generate soybean material; mixing the soybean material or the soybean meal with water, recycled water, or stillage to generate a slurry; heating and adjusting a pH of the slurry to be acidic, thereby generating a heated slurry; cooking the heated slurry at a temperature between 220° F. and 280° F., thereby generating a cooked slurry; cooling and adjusting a pH of the cooked slurry; adding an enzyme to the cooked slurry to initiate enzymatic hydrolysis and saccharification, thereby generating a soybean mash; fermenting the soybean mash with yeast capable of utilizing C5 and C6 sugars to generate a soybean beer including ethanol; removing ethanol from the soybean beer in an ethanol recovery unit; collecting a high protein stillage from the ethanol recovery unit; removing soybean oil from the high protein stillage, thereby generating de-oiled high protein stillage; and concentrating the de-oiled high protein stillage.

In some aspects, the techniques described herein relate to a system for processing soybean material, the system including: a size reduction unit in communication with a soybean storage unit, the size reduction unit configured to receive feedstock from the soybean storage unit and reduce a particle size of the feedstock and generate soybean meal; a slurry mix tank configured to receive the soybean meal and a liquid media and generate a slurry, the slurry mix tank including heating components configured to heat contents of the slurry mix tank to a temperature between 175° F. and 212° F.; a reactor unit in communication with the slurry mix tank and configured to heat contents of the reactor unit to a temperature between 220° F. and 280° F. and pressurize to a pressure between 18 psia and 50 psia; a cooling unit in communication with the reactor unit and configured to reduce the pressure and temperature of reacted material received from the reactor unit; a hydrolysis mixing tank configured to receive cooled material from the cooling unit, pH adjustment material, and enzymatic material; a fermentation tank in communication with the hydrolysis mixing tank, the fermentation tank configured to receive yeast; an ethanol recovery unit in communication with the fermentation tank, the ethanol recovery unit including components configured to separate ethanol from soybean beer generated in the fermentation tank; an separation unit configured to receive stillage from the ethanol recovery unit, the separation unit configured to separate oil from the stillage; a dryer unit in communication with a retentate stream from the separation unit, the dryer unit configured to dry the retentate and generate solid protein material; an evaporation unit in communication with a filtrate stream from the separation unit, the evaporation unit configured to generate a concentrated liquid; and an oil recovery unit configured to receive the concentrated liquid from the evaporation unit, the oil recovery unit configured to separate oil from other constituents in the concentrated liquid.

### BRIEF DESCRIPTION OF THE DRAWINGS

FIG. 1 schematically shows an exemplary system for processing soybean material.

FIG. 2 shows an example method for processing soybean material.

FIG. 3 shows amino acid analysis results of experimentally generated protein feed samples for various process conditions.

### DETAILED DESCRIPTION

Generally, the present disclosure is directed to systems and methods for processing soybeans. Exemplary systems and methods may be capable of generating ethanol and a high protein product. As used herein, “high protein” means material comprising at least 50 percent by weight (wt %) protein. Broadly, exemplary systems and methods use thermo-mechanical-chemical methods to process soybeans and then use enzymes and yeast (or other organisms) to generate ethanol.

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” is used to indicate that exact values are not necessarily attainable. Therefore, the term “about” is used to indicate this uncertainty limit. The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5-1.4. The modifier “about” should also be considered as disclosing the range defined by the absolute values of the two endpoints. For example, the expression “from about 2 to about 4” also discloses the range “from 2 to 4.”

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

### II. Exemplary Systems

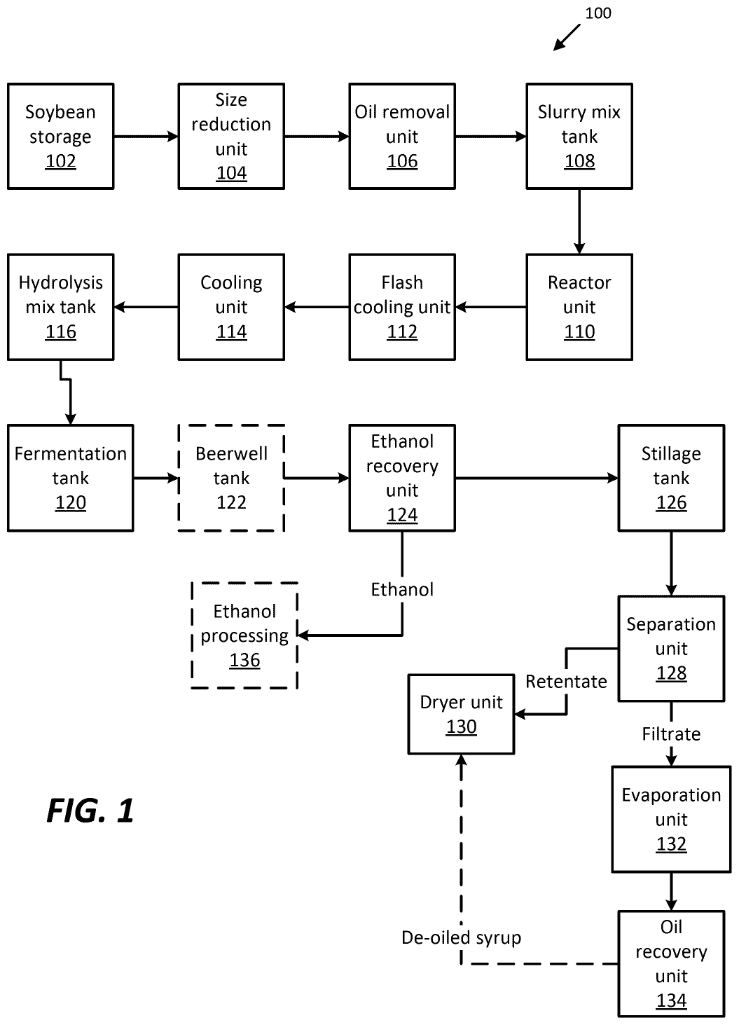

FIG. 1 schematically shows an exemplary system 100 for processing soybean material. As shown, the exemplary system includes soybean storage 102, size reduction unit 104, oil removal unit 106, slurry mix tank 108, reactor unit 110, flash cooling unit 112, cooling unit 114, hydrolysis mixing tank 116, fermentation tank 120, ethanol recovery unit 124, stillage tank 126, separation unit 128, protein feed dryer unit 130, evaporation unit 132, and oil recovery unit 134. Exemplary system 100 may optionally include beerwell tank 122 and/or ethanol processing 136. Various components shown in FIG. 1 may be in fluid communication with each other. The exemplary system may be configured to operate in batch or continuous operation. Other embodiments may include more or fewer components.

Soybean storage 102 retains soybean material used as feedstock. In some instances, soybean storage 102 may provide feedstock to size reduction unit 104. In some instances, soybean storage 102 may include a hopper in communication with size reduction unit.

Size reduction unit 104 reduces the particle size of the feedstock. Size reduction unit 104 may include one or more components configured to generate soybean meal. For instance, size reduction unit 104 may include multiple components arranged in parallel or series. Exemplary components may include a hammermill, a rollermill, and/or a press.

Oil removal unit 106 removes a portion of oil from the soybean meal generated by size reduction unit 104. Various components known in the art may be used to remove a portion of the oil. For instance, oil removal unit 106 may include an extruder/expeller.

Soybean material generated by oil removal unit 106 is provided to slurry mix tank 108. A slurry comprising the soybean material is generated in slurry mix tank 108. Various liquid media may be used to generate the slurry, such as water, recycled water, or stillage.

Additional material may be added to the slurry mix tank 108. For instance, pH adjusting material may be added to achieve a target pH range of the slurry. For instance, enzymatic material may be added to the slurry mix tank 108.

In some instances, slurry mix tank 108 may comprise heating components, such as a heat jacket, configured to heat the contents of the slurry mix tank 108. As an example, slurry mix tank 108 may be configured to heat the slurry to a temperature between 175° F. and 212° F. Other possible temperatures are discussed in greater detail below.

Reactor unit 110 cooks the slurry generated in the slurry mix tank 108. Reactor unit 110 includes temperature and pressure regulation components. Reactor unit 110 may be configured as a batch reactor or a continuous reactor. In some instances, reactor unit 110 may be a pipe or tube, thereby enabling continuous operation.

In some instances, reactor unit 110 may be configured to heat the reactor contents to a temperature between 220° F. and 280° F. In some instances, reactor unit 110 may be configured to maintain the temperature, between 220° F. and 280° F. Other possible temperatures are discussed in greater detail below.

In some implementations, steam may be mixed with the slurry to raise the temperature of the slurry prior to entering the reactor unit 110. In some instances, a separate unit from the reactor unit 110 may be used to heat the slurry. Various direct inject steam configurations known in the art may be used. A commercially available example of a heating unit is the Hydroheater™ from Hydro-Thermal Corporation (Waukesha, Wisconsin). Without being bound by a particular theory, the shear generated in direct inject steam configurations may beneficially break up the soybean material particles in the slurry, which in turn may result in more surface area of soybean material particles for reactions to take place in downstream operations. Heating of the process stream may also be accomplished by utilizing a heat exchange unit(s) where heat is indirectly transferred from steam or other heated fluid.

In various instances, steam may be added to the slurry at an amount between about 5 wt % to about 10 wt %, in terms of the weight of steam to the total slurry weight. In various implementations, steam may be added to the slurry at an amount between 5 wt % to 10 wt %; between 5 wt % and 7.5 wt %; between 7.5 wt % and 10 wt %; or between 6 wt % and 9 wt %, in terms of the weight of steam to the total slurry weight. In various implementations, steam may be added to the slurry at an amount no less than 5 wt %; no less than 6 wt %; no less than 7 wt %; no less than 8 wt %; no less than 9 wt %; or no less than 10 wt %, in terms of the weight of steam to the total slurry weight. In various implementations, steam may be added to the slurry at an amount no greater than 5 wt %; no greater than 6 wt %; no greater than 7 wt %; no greater than 8 wt %; no greater than 9 wt %; or no greater than 10 wt %, in terms of the weight of steam to the total slurry weight.

Reactor unit 110 may be configured to pressurize the reactor contents to a pressure between 18 psia and 50 psia. Other possible pressures are discussed in greater detail below.

Reactor unit 110 may be arranged, and receive material at a flow rate, such that a residence time in the reactor unit 110 is between 5 minutes and 60 minutes.

Flash cooling unit 112 cools reacted material received from reactor unit 110. In some instances, flash cooling unit includes a valve for flash cooling. In those instances, reacted material passes through a valve with pressure on the feed side and a vacuum on the other side of the valve. As reacted material passes through the valve, the material flashes down to the cooled temperature.

Flash cooling unit 112 may also reduce the pressure of reacted material received from reactor unit 110. In some implementations, flash cooling unit 112 cools the reacted material to a temperature between 150° F. and 212° F. Other possible temperatures are discussed in greater detail below. In some implementations, flash cooling unit 112 reduces the pressure of the reacted material to a pressure between atmospheric pressure and 4 psia.

Various components known in the art may be used to flash cool the reacted material. In some instances, flash cooling unit 112 includes heat exchange components such that heat recovered from the reacted material may be used elsewhere in system 100.

Cooling unit 114 receives material from flash cooling unit 112 and trim cools the material. Cooling unit 114 may include heat exchange components. Cooling unit 114 may be configured to reduce the reacted material temperature to between 130° F. and 175° F. Other possible temperatures are discussed in greater detail below.

Hydrolysis mix tank 116 mixes cooled material from cooling unit 114, pH adjustment material when necessary, and enzymatic material, and generates hydrolyzed material. Hydrolysis mix tank 116 may include temperature regulation components to maintain tank contents at a temperature between 130° F. and 175° F. Other possible temperatures are discussed in greater detail below.

After a predetermined amount of time, hydrolyzed material from the hydrolysis mix tank 116 are provided to fermentation tank 120.

In fermentation tank 120, hydrolyzed material is combined with yeast and tank contents undergo fermentation, thereby generating soybean beer. Fermentation tank 120 may include temperature regulation components to maintain tank contents at a temperature between 88° F. and 95° F. Other possible temperatures are discussed in greater detail below.

In some instances, soybean beer may be provided from fermentation tank 120 to beerwell tank 122. Beerwell tank 122 may function as a surge tank.

Soybean beer is then provided to ethanol recovery unit 124. Ethanol recovery unit 124 separates ethanol from the soybean beer. In some implementations, ethanol recovery unit 124 may include a series of separation units. Various material separation units may be used for ethanol recovery unit 124. For example, one or more distillation units may be used in ethanol recovery unit 124.

Ethanol recovery unit 124 generates at least two streams: an ethanol stream and a stillage stream. In some instances, the ethanol stream may be provided to ethanol processing 136. Ethanol processing 136 may further process the ethanol stream and purified. Various units known in the art for purifying ethanol may be used in ethanol processing 136.

The stillage stream, which usually comprises less than 0.10% weight by volume ethanol, is further processed. In some instances, stillage is provided from ethanol recovery unit 124 to stillage tank 126. Stillage tank 126 holds the stillage generated by ethanol recovery unit 124 and provides a stillage stream to separation unit 128.

Separation unit 128 separates the stillage stream into a high suspended solids stream (retentate) and a low suspended solids stream (filtrate). In some implementations, separation unit 128 may include a plurality of units operating in parallel and/or series. Various separation devices may be used, such as screening units, decanting units, centrifuges, clarifier units, and/or membrane filtration.

Retentate from separation unit 128 may be provided to dryer unit 130. Dryer unit 130 dries the high suspended solids stream, also referred to as a protein cake, to remove some or all water content. Various drying units known in the art may be used in dryer unit 130.

Evaporation unit 132 processes filtrate from separation unit 128 to concentrate solids in the filtrate and generate a concentrated liquid (a syrup or viscous liquid). Evaporation unit 132; removes water content from the filtrate by heating the filtrate.

A resulting syrup generated by evaporation unit may be further processed in oil recovery unit 134 to remove oil. The syrup may comprise between about 40 wt % to about 80 wt % water.

Oil recovery unit 134 separates oil from other constituents in the syrup generated by evaporation unit 132. Various devices may be used in oil recovery unit 134, such as filtration units. In some instances, de-oiled syrup generated by oil recovery unit 134 may be provided to dryer unit 130 for further processing.

### III. Exemplary Methods

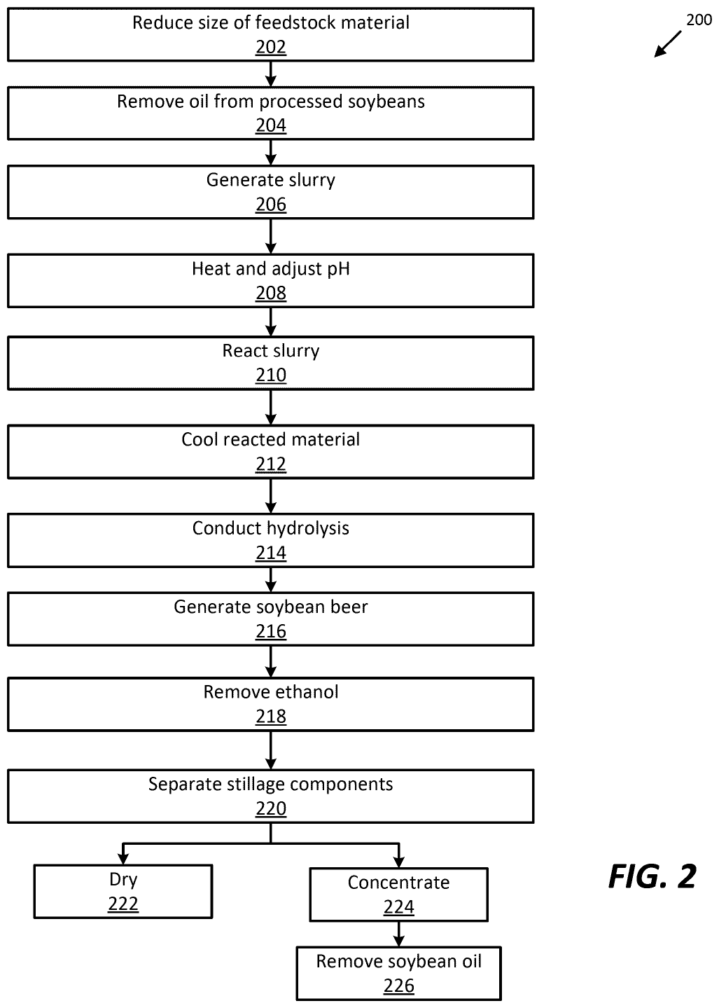

FIG. 2 shows an example method 200 for processing soybean material. As shown, method 200 includes reducing a size of feedstock material (operation 202), removing oil from processed soybeans (operation 204), generating a slurry (operation 206), heating and adjusting a pH (operation 208), reacting the slurry (operation 210), cooling reacted material (operation 212), conducting hydrolysis (operation 214), generating soybean beer (operation 216), removing ethanol (operation 218), separating stillage components (operation 220), drying (operation 222), concentrating (operation 224), and removing soybean oil (operation 226). Other embodiments may include more or fewer operations.

The example method begins with reducing a size of a feedstock material (operation 202). The feedstock may comprise raw soybeans, roasted soybeans, or soybean meal. In some instances, the soybean hull has been removed from the raw soybeans or roasted soybeans. In some instances, the soybean hull from the raw soybeans or roasted soybeans is intact. However, the soybean pod from the raw soybeans or roasted soybeans has been removed.

Soybean meal, as used herein, refers to soybean material that has been previously processed to reduce the amount of oil that is present. In some instances, feedstock material may comprise soybeans that were pre-processed with hexane to remove oil. In some instances, feedstock material may comprise soybeans that were pre-processed with pressing to remove oil.

When the feedstock comprises soybean meal, the feedstock is provided to a slurry mix tank (operation 206). Various aspects of an generating a slurry are discussed in greater detail below.

When the feedstock comprises raw soybeans and/or roasted soybeans, the feedstock is processed in a size reduction unit to reduce particle size and expose the soybean surface area for treatment. The size reduction unit generates soybean meal. As discussed above, the size reduction unit may be a hammermill or a rollermill, and/or a press.

Soybeans may be processed until they have a predetermined particle size. In some instances, soybeans may be processed until they have a particle size (Dᵥ(50)) of a No. 20 sieve; of a No. 16 sieve; or of a No. 14 sieve. In some instances, soybeans may be processed until they have a particle size (Dᵥ(50)) between 0.76 mm and 0.92 mm. In some instances, soybeans may be processed until at least 60% by volume; at least 70% by volume; or at least 80% by volume of the particles pass through a No. 12 sieve.

Method 200 may include removing oil from the soybean meal (operation 204). In some instances, method 200 may include determining an oil content of the feedstock and, when the feedstock comprises more than 12 wt % oil on a dry basis, oil may be removed from the feedstock. During operation 204, a portion of the raw bean oil is removed from the soybean meal. As discussed above, an extruder/expeller may be used to remove a portion of the raw bean oil.

The de-oiled soybean meal, which may be termed soybean material, may then be mixed with water, recycled water, or stillage, to generate a slurry (operation 206). Slurry generated during operation 206 may have a total solids content between 10 wt % and 30 wt %. In various implementations, slurry generated during operation 206 may have a total solids content between 10 wt % and 20 wt %; between 20 wt % and 30 wt %; or between 15 wt % and 25 wt %. In various implementations, slurry generated during operation 206 may have a total solids content no less than 10 wt %; no less than 15 wt %; no less than 20 wt %; no less than 25 wt %; or no less than 30 wt %. In various implementations, slurry generated during operation 206 may have a total solids content no greater than 10 wt %; no greater than 15 wt %; no greater than 20 wt %; no greater than 25 wt %; or no greater than 30 wt %.

Acidic material may be added to adjust a pH to be between about 2.5 and about 6.0 (operation 208). In some instances, various acids may be used to adjust the pH. Exemplary acids may include sulfuric acid, sulfurous acid, and phosphoric acid. In various implementations, during operation 208 the pH may be adjusted to be between 2.5 and 6.0; between 2.5 and 4.0; between 4.0 and 6.0; between 2.5 and 3.5; between 3.5 and 4.5; or between 4.5 and 6.0. In various implementations, during operation 208 the pH may be adjusted to be no less than 2.5; no less than 3.0; no less than 3.5; no less than 4.0; no less than 4.5; no less than 5.0; no less than 5.5; or no less than 6.0. In various implementations, during operation 208 the pH may be adjusted to be no greater than 2.5; no greater than 3.0; no greater than 3.5; no greater than 4.0; no greater than 4.5; no greater than 5.0; no greater than 5.5; or no greater than 6.0.

In some instances, method 200 may include adding an enzyme to the slurry. Adding the enzyme may start conversion reactions. An example enzyme is an alpha amylase.

In the mixing tank, the slurry may be heated to a predetermined temperature. In some instances, the predetermined temperature is between about 175° F. and about 212° F. In various implementations, the slurry may be heated to a temperature between 175° F. and 212° F.; between 175° F. and 193° F.; between 193° F. and 212° F.; between 175° F. and 185° F.; between 185° F. and 195° F.; between 195° F. and 205° F.; or between 205° F. and 212° F. In various implementations, the slurry may be heated to a temperature no less than 175° F.; no less than 180° F.; no less than 185° F.; no less than 190° F.; no less than 195° F.; no less than 200° F.; no less than 205° F.; no less than 210° F.; or no less than 212° F. In various implementations, the slurry may be heated to a temperature no greater than 175° F.; no greater than 180° F.; no greater than 185° F.; no greater than 190° F.; no greater than 195° F.; no greater than 200° F.; no greater than 205° F.; no greater than 210° F.; or no greater than 212° F.

Next, the slurry is reacted/cooked (operation 210) to start the process of converting starch and fiber to C5 and/or C6 sugars. Cooking the slurry may be at a temperature between about 220° F. and about 280° F. In various implementations, the slurry may be cooked at a temperature between 220° F. and 280° F.; between 220° F. and 250° F.; between 250° F. and 280° F.; between 220° F. and 240° F.; between 240° F. and 260° F.; or between 260° F. and 280° F. In various implementations, the slurry may be cooked at a temperature no less than 220° F.; no less than 230° F.; no less than 240° F.; no less than 250° F.; no less than 260° F.; no less than 270° F.; or no less than 280° F. In various implementations, the slurry may be cooked at a temperature no greater than 220° F.; no greater than 230° F.; no greater than 240° F.; no greater than 250° F.; no greater than 260° F.; no greater than 270° F.; or no greater than 280° F.

Cooking the slurry may be performed at a pressure between about 18 psia and about 50 psia. In various implementations, cooking the slurry may be performed at a pressure between 18 psia and 50 psia; between 18 psia and 33 psia; between 33 psia and 50 psia; between 18 psia and 28 psia; between 28 psia and 38 psia; or between 38 psia and 50 psia. In various implementations, cooking the slurry may be performed at a pressure no less than 18 psia; no less than 23 psia; no less than 28 psia; no less than 33 psia; no less than 38 psia; no less than 43 psia; no less than 47 psia; or no less than 50 psia. In various implementations, cooking the slurry may be performed at a pressure no greater than 18 psia; no greater than 23 psia; no greater than 28 psia; no greater than 33 psia; no greater than 38 psia; no greater than 43 psia; no greater than 47 psia; or no greater than 50 psia.

In some instances, acid may be added to adjust the pH to be between 2.5 and 6.0. In various implementations, during operation 208 the pH may be adjusted to be between 2.5 and 6.0; between 2.5 and 4.0; between 4.0 and 6.0; between 2.5 and 3.5; between 3.5 and 4.5; or between 4.5 and 6.0. In various implementations, during operation 208 the pH may be adjusted to be no less than 2.5; no less than 3.0; no less than 3.5; no less than 4.0; no less than 4.5; no less than 5.0; no less than 5.5; or no less than 6.0. In various implementations, during operation 208 the pH may be adjusted to be no greater than 2.5; no greater than 3.0; no greater than 3.5; no greater than 4.0; no greater than 4.5; no greater than 5.0; no greater than 5.5; or no greater than 6.0.

Cooking the slurry may be performed for a predetermined time in a reactor. An exemplary reactor may be a pressure vessel, pipe, and the like. The predetermined time may be between about 5 minutes and about 60 minutes. In various implementations, cooking the slurry may be performed for a time period between 5 minutes and 60 minutes; between 5 minutes and 30 minutes; between 30 minutes and 60 minutes; or between 20 minutes and 50 minutes. In various implementations, cooking the slurry may be performed for a time period no less than 5 minutes; no less than 10 minutes; no less than 15 minutes; no less than 20 minutes; no less than 25 minutes; no less than 30 minutes; no less than 35 minutes; no less than 40 minutes; no less than 45 minutes; no less than 50 minutes; no less than 55 minutes; or no less than 60 minutes. In various implementations, cooking the slurry may be performed for a time period no greater than 5 minutes; no greater than 10 minutes; no greater than 15 minutes; no greater than 20 minutes; no greater than 25 minutes; no greater than 30 minutes; no greater than 35 minutes; no greater than 40 minutes; no greater than 45 minutes; no greater than 50 minutes; no greater than 55 minutes; or no greater than 60 minutes.

The reacted material is then cooled (operation 212). Cooling the reacted material may include flash cooling to a target temperature. In some instances, the target temperature for cooling the reacted material may be between about 150° F. and about 212° F. In various implementations, the reacted material may be cooled to a temperature between 150° F. and 212° F.; between 150° F. and 180° F.; between 180° F. and 212° F.; between 150° F. and 175° F.; between 175° F. and 212° F.; between 175° F. and 193° F.; between 193° F. and 212° F.; between 175° F. and 185° F.; between 185° F. and 195° F.; between 195° F. and 205° F.; or between 205° F. and 212° F. In various implementations, the reacted material may be cooled to a temperature no less than 150° F.; no less than 155° F.; no less than 160° F.; no less than 165° F.; no less than 170° F.; no less than 175° F.; no less than 180° F.; no less than 185° F.; no less than 190° F.; no less than 195° F.; no less than 200° F.; no less than 205° F.; no less than 210° F.; or no less than 212° F. In various implementations, the reacted material may be cooled to a temperature no greater than 150° F.; no greater than 155° F.; no greater than 160° F.; no greater than 165° F.; no greater than 170° F.; no greater than 175° F.; no greater than 180° F.; no greater than 185° F.; no greater than 190° F.; no greater than 195° F.; no greater than 200° F.; no greater than 205° F.; no greater than 210° F.; or no greater than 212° F.

In some instances, the reacted material pressure may be reduced to be between about 4 psia and about atmospheric pressure. In various implementations, the reacted material pressure may be reduced to be no greater than 4 psia; no greater than 3 psia; no greater than 2 psia; or no greater than atmospheric pressure.

Heat from the pretreated material may be recovered to other system components. For instance, heat recovered may be provided to the distillation unit.

After flash cooling, the reacted material may be trim cooled to the appropriate temperature to optimize enzyme efficiency. Trim cooling may reduce the reacted material temperature to be between about 130° F. and about 175° F. In various implementations, trim cooling may reduce the reacted material temperature to be between 130° F. and 175° F.; between 130° F. and 150° F.; between 150° F. and 175° F.; between 130° F. and 145° F.; between 145° F. and 160° F.; or between 160° F. and 175° F. In various implementations, trim cooling may reduce the reacted material temperature to be no less than 130° F.; no less than 135° F.; no less than 140° F.; no less than 145° F.; no less than 150° F.; no less than 155° F.; no less than 160° F.; no less than 165° F.; no less than 170° F.; or no less than 175° F. In various implementations, trim cooling may reduce the reacted material temperature to be no greater than 130° F.; no greater than 135° F.; no greater than 140° F.; no greater than 145° F.; no greater than 150° F.; no greater than 155° F.; no greater than 160° F.; no greater than 165° F.; no greater than 170° F.; or no greater than 175° F.

After, or during trim cooling, the pH of the reacted material may be adjusted to optimal conditions for enzymatic hydrolysis. For instance, the pH may be adjusted to be between about 4 and about 6. In various implementations, the pH may be adjusted to be between 4 and 6; between 4.5 and 5.5; between 4.8 and 5.2; between 4 and 4.5; between 4.5 and 5; between 5 and 5.5; or between 5.5 and 6. In various implementations, the pH may be adjusted to be no less than 4; no less than 4.5; no less than 5.0 no less than 5.5; or no less than 6.0. In various implementations, the pH may be adjusted to be no greater than 4; no greater than 4.5; no greater than 5.0 no greater than 5.5; or no greater than 6.0.

In some instances, pH adjustment may be accomplished by adding basic material to the reacted material. Various bases may be used for pH adjustment. For instance, exemplary basic material may comprise sodium hydroxide, ammonium hydroxide, and/or potassium hydroxide.

Next, the mixture may be provided to a mixing tank where enzymatic hydrolysis reactions occur (operation 214). A soybean mash may be generated during operation 214. One or more enzymes may be added to the mixing tank. Exemplary enzymes may include: alpha amylase, cellulase, hemicellulase, pectinase, glucoamylase, and combinations thereof.

In various instances, a target retention time in the mixing tank may be between about 20 hours and about 48 hours. In various implementations, a target retention time in the mixing tank may be between 20 hours and 48 hours; between 20 hours and 30 hours; between 30 hours and 48 hours; or between 25 hours and 35 hours. In various implementations, a target retention time in the mixing tank may be no less than 20 hours; no less than 24 hours; no less than 28 hours; no less than 32 hours; no less than 36 hours; no less than 40 hours; no less than 44 hours; or no less than 48 hours. In various implementations, a target retention time in the mixing tank may be no greater than 20 hours; no greater than 24 hours; no greater than 28 hours; no greater than 32 hours; no greater than 36 hours; no greater than 40 hours; no greater than 44 hours; or no greater than 48 hours.

The mixing tank may maintain a temperature of the mixture to be between 130° F. and 175° F. In various implementations, the temperature of the material in the mixing tank may be maintained to be between 130° F. and 175° F.; between 130° F. and 150° F.; between 150° F. and 175° F.; between 130° F. and 145° F.; between 145° F. and 160° F.; or between 160° F. and 175° F. In various implementations, the temperature of the material in the mixing tank may be maintained to be no less than 130° F.; no less than 135° F.; no less than 140° F.; no less than 145° F.; no less than 150° F.; no less than 155° F.; no less than 160° F.; no less than 165° F.; no less than 170° F.; or no less than 175° F. In various implementations, the temperature of the material in the mixing tank may be maintained to be no greater than 130° F.; no greater than 135° F.; no greater than 140° F.; no greater than 145° F.; no greater than 150° F.; no greater than 155° F.; no greater than 160° F.; no greater than 165° F.; no greater than 170° F.; or no greater than 175° F.

After reacting in the mixing tank, soybean mash may be provided to a fermentation tank to generate soybean beer (operation 216). Yeast may be added to the material in the fermentation tank. In some instances, between about 0.0063% to about 0.0188% dry yeast weight/fermented dry solids weight may be added to the fermentation tank. In various implementations, between 0.0063% and 0.0188%; between 0.0063% and 0.01255%; or between 0.01255% and 0.0188% dry yeast weight/fermented dry solids weight may be added to the fermentation tank. In various implementations, dry yeast may be added in an amount no less than 0.0063%; no less than 0.009%; no less than 0.011%; no less than 0.013%; no less than 0.015%; no less than 0.017%; or no less than 0.0188% dry yeast weight/fermented dry solids weight. In various implementations, dry yeast may be added in an amount no greater than 0.0063%; no greater than 0.009%; no greater than 0.011%; no greater than 0.013%; no greater than 0.015%; no greater than 0.017%; or no greater than 0.0188% dry yeast weight/fermented dry solids weight.

Exemplary yeast is capable of converting C5 and/or C6 sugars. An exemplary yeast may be cV-110 Saccharomyces cerevisiae strain available from Terranol A/S (Copenhagen, Denmark). Other carbohydrate consuming organisms (such as bacteria, fungi, etc.) may be added to enhance ethanol yield and co-product value.

In some instances, yeast may be added directly to the fermentation tank. In some instances, yeast may be propagated by batch or fed batch propagation.

When method 200 includes batch propagation, material from the hydrolysis mix tank is transferred to a yeast propagation vessel. That material is adjusted to predetermined temperature, pH, and solids ranges. For instance, the material may be adjusted to have a pH between about 4.5 and about 5.5. In various implementations, the material may be adjusted to have a pH between 4.5 and 5.5; between 4.5 and 5.0; between 5.0 and 5.5; or between 4.75 and 5.25. In various implementations, the material may be adjusted to have a pH no less than 4.5; no less than 4.75; no less than 5.0; no less than 5.25; or no less than 5.5. In various implementations, the material may be adjusted to have a pH no greater than 4.5; no greater than 4.75; no greater than 5.0; no greater than 5.25; or no greater than 5.5.

For instance, the material temperature may be adjusted to be between about 88° F. and about 95° F. In various implementations, the material temperature may be adjusted to be between 88° F. and 95° F.; between 88° F. and 92° F.; between 92° F. and 95° F.; or between 90° F. and 93° F. In various implementations, the material temperature may be adjusted to be no less than 88° F.; no less than 89° F.; no less than 90° F.; no less than 91° F.; no less than 92° F.; no less than 93° F.; no less than 94° F.; or no less than 95° F. In various implementations, the material temperature may be adjusted to be no greater than 88° F.; no greater than 89° F.; no greater than 90° F.; no greater than 91° F.; no greater than 92° F.; no greater than 93° F.; no greater than 94° F.; or no greater than 95° F.

For instance, the solids content may be adjusted to be between about 5 wt % and about 15 wt %. Dilution of solids may be accomplished by addition of water or process condensate. In various implementations, the solids content may be adjusted to be between 5 wt % and 15 wt %; between 5 wt % and 10 wt %; between 10 wt % and 15 wt %; or between 7 wt % and 12 wt %. In various implementations, the solids content may be adjusted to be no less than 5 wt %; no less than 7 wt %; no less than 9 wt %; no less than 11 wt %; no less than 13 wt %; or no less than 15 wt %. In various implementations, the solids content may be adjusted to be no greater than 5 wt %; no greater than 7 wt %; no greater than 9 wt %; no greater than 11 wt %; no greater than 13 wt %; or no greater than 15 wt %.

In some instances, antimicrobial material may be added to prevent bacterial contamination. In some instances, yeast nutrients may be added. Then, the yeast may be propagated for a time period between about 5 hours to about 15 hours. In various implementations, the yeast is propagated for a time period between 5 hours and 15 hours; between 5 hours and 10 hours; between 10 hours and 15 hours; or between 7 hours and 12 hours. In various implementations, the yeast is propagated for a time period no less than 5 hours; no less than 7 hours; no less than 9 hours; no less than 11 hours; no less than 13 hours; or no less than 15 hours. In various implementations, the yeast is propagated for a time period no greater than 5 hours; no greater than 7 hours; no greater than 9 hours; no greater than 11 hours; no greater than 13 hours; or no greater than 15 hours.

When method 200 includes fed-batch propagation, the same operations are performed as for batch propagation but with additional operations. For instance, fed-batch propagation includes transferring additional material from the hydrolysis mixing tank to the propagation vessel, which facilitates yeast propagation under reduced stress conditions. The additional material may be provided to the propagation vessel between 0 to 6 hours after the start of propagation through the end of propagation (which lasts 5 hours to 15 hours).

The fermentation tank may maintain material temperature between about 88° F. and about 95° F. In various implementations, the material temperature in the fermentation tank may be maintained to be between 88° F. and 95° F.; between 88° F. and 92° F.; between 92° F. and 95° F.; or between 90° F. and 93° F. In various implementations, the material temperature in the fermentation tank may be maintained to be no less than 88° F.; no less than 89° F.; no less than 90° F.; no less than 91° F.; no less than 92° F.; no less than 93° F.; no less than 94° F.; or no less than 95° F. In various implementations, the material temperature in the fermentation tank may be maintained to be no greater than 88° F.; no greater than 89° F.; no greater than 90° F.; no greater than 91° F.; no greater than 92° F.; no greater than 93° F.; no greater than 94° F.; or no greater than 95° F.

The pH in the fermentation tank may be maintained to be between 4.5 and 5.5. In various implementations, the pH in the fermentation tank may be maintained to be between 4.5 and 5.5; between 4.5 and 5.0; between 5.0 and 5.5; or between 4.75 and 5.25. In various implementations, the pH in the fermentation tank may be maintained to be no less than 4.5; no less than 4.75; no less than 5.0; no less than 5.25; or no less than 5.5. In various implementations, the pH in the fermentation tank may be maintained to be no greater than 4.5; no greater than 4.75; no greater than 5.0; no greater than 5.25; or no greater than 5.5.

A retention time of material in the fermentation tank may be between about 20 hours and about 60 hours. In various implementations, a retention time of material in the fermentation tank may be between 20 hours and 60 hours; between 20 hours and 40 hours; between 40 hours and 60 hours; or between 30 hours and 50 hours. In various implementations, a retention time of material in the fermentation tank may be no less than 20 hours; no less than 30 hours; no less than 40 hours; no less than 50 hours; or no less than 60 hours. In various implementations, a retention time of material in the fermentation tank may be no greater than 20 hours; no greater than 30 hours; no greater than 40 hours; no greater than 50 hours; or no greater than 60 hours.

After fermentation, the material, which is now soybean beer, may then be provided to a beerwell tank. The soybean beer may comprise between 1.0 weight by volume percent (w/v %) and 4.0 w/v % ethanol. Ethanol in the soybean beer may be derived from cellulose and starches.

The soybean beer may then be provided to a distillation system where heat is applied in order to remove ethanol (operation 218) by boiling. The distillation system may be operated such that overhead streams comprise ethanol that is between 20 proof and 80 proof. The temperature and pressure of the distillation system may be adequate to produce a bottoms stream with less than 0.10% w/v % ethanol. The ethanol stream may then be further processed and purified to at least 180 proof; at least 190 proof; or at least 200 proof ethanol. In some instances, the ethanol may be purified to be fuel grade ethanol.

In some instances, the leftover, high protein stillage may be provided to a stillage tank. The high protein stillage may comprise less than 0.10 w/v % ethanol.

Method 200 includes separating the high protein stillage (operation 220) into a high suspended solids stream (retentate) and a low suspended solids stream (filtrate). One or more units may be used to separate the high protein stillage. For instance, screening units, decanting units, centrifuges, clarifier units, and/or membrane filtration may be used to separate the high protein stillage.

Method 200 may include drying (operation 222) the high suspended solids stream (the protein cake) to yield a high protein product. The high protein product (de-oiled) may comprise between about 50 wt % and about 80 wt % protein on a dry matter basis, calculated assuming 100% water removal. In various implementations, the de-oiled, high protein product may comprise a protein content between 50 wt % and 80 wt %; between 50 wt % and 65 wt %; between 65 wt % and 80 wt %; or between 60 wt % and 70 wt % on a dry matter basis. In various implementations, the de-oiled, high protein product may comprise a protein content no less than 50 wt %; no less than 55 wt %; no less than 60 wt %; no less than 65 wt %; no less than 70 wt %; no less than 75 wt %; or no less than 80 wt % on a dry matter basis. In various implementations, the de-oiled, high protein product may comprise a protein content no greater than 50 wt %; no greater than 55 wt %; no greater than 60 wt %; no greater than 65 wt %; no greater than 70 wt %; no greater than 75 wt %; or no greater than 80 wt % on a dry matter basis.

Method 200 may include concentrating (operation 224) the low suspended solids stream (the filtrate/centrate). For instance, concentrating (operation 224) may comprise one or more of: centrifuging the de-oiled high protein stillage; screening the concentrated de-oiled high protein stillage; evaporating the concentrated de-oiled high protein stillage; and drying the concentrated de-oiled high-protein stillage. As mentioned above, the filtrate may be provided to an evaporation unit and/or a filtration unit to perform various concentrating operations.

Method 200 may include removing/recovering soybean oil (operation 226). Removing soybean oil may be performed using techniques known in the art, such as through centrifugation.

### IV. Experimental Examples

Experiments were conducted and various results are discussed below.

Expeller meal was mixed with process condensate (PC) to create a slurry targeting approximately 22% solids. Press cake was mixed with process condensate to create a slurry targeting 12% solids. It was observed that 22% solids with press cake was too viscous for pumping. Solvent extracted soybean meal was mixed with process condensate to create a slurry targeting 15% solids. It was observed that 22% solids with solvent extracted soybean meal was too viscous for pumping. Raw whole soybeans were also used with an extra step of processing through a roller mill down to 0.025 inches.

Depending on the condition, pH adjustment was performed with concentrated sulfuric acid to the desired pH (Note: pH of 5.6 is the pH of soybean and PC slurry with no acid addition). Table 1 below details various conditions trialed during the experiments.

TABLE 1
Time, temperature, and pH conditions for different trials.

| | | Time | Temp | Temp | | |
|---|---|---|---|---|---|---|
| Condition | Material | (min) | (° F.) | (° C.) | pH | Note |
| 1 | Raw Beans, roller milled | 10 | 221 | 105 | 2.5 | |
| 2 | Raw Beans, roller milled | 10 | 221 | 105 | 5.6 | |
| 3 | Raw Beans, roller milled | 10 | 276.8 | 136 | 2.5 | |
| 4 | Raw Beans, roller milled | 10 | 276.8 | 136 | 5.6 | |
| 5 | Raw Beans, roller milled | 20 | 249.8 | 121 | 4.05 | |
| 6 | Raw Beans, roller milled | 30 | 221 | 105 | 2.5 | |
| Modified 6 | Raw Beans, roller milled | 30 | 221 | 105 | 2.5 | Added cook |
| | | | | | | step prior to |
| | | | | | | pretreatment |
| 7 | Raw Beans, roller milled | 30 | 221 | 105 | 5.6 | |
| 8 | Raw Beans, roller milled | 30 | 276.8 | 136 | 2.5 | |
| 9 | Raw Beans, roller milled | 30 | 276.8 | 136 | 5.6 | |
| 10 | Raw Beans, roller milled | 10 | 240.8 | 116 | 2.5 | |
| 11 | Raw Beans, roller milled | 10 | 240.8 | 116 | 5.6 | |
| 12 | Raw Beans, roller milled | 30 | 240.8 | 116 | 5.6 | |
| Expeller 4 | Expeller bean meal | 10 | 276.8 | 136 | 5.6 | |
| Expeller 8 | Expeller bean meal | 30 | 276.8 | 136 | 2.5 | |
| Press Cake 1 | Pressed Soybean Cake | 10 | 240.8 | 116 | 4.0 | |
| Press Cake 2 | Pressed Soybean Cake | 10 | 240.8 | 116 | 5.5 | |
| Press Cake 3 | Pressed Soybean Cake | 10 | 276.8 | 136 | 4.0 | |
| Press Cake 4 | Pressed Soybean Cake | 10 | 276.8 | 136 | 5.5 | |
| Press Cake 5 | Pressed Soybean Cake | 20 | 258.8 | 126 | 4.7 | |
| Press Cake 6 | Pressed Soybean Cake | 30 | 240.8 | 116 | 4.0 | |
| Press Cake 7 | Pressed Soybean Cake | 30 | 240.8 | 116 | 5.5 | |
| Press Cake 8 | Pressed Soybean Cake | 30 | 276.8 | 136 | 4.0 | |
| Press Cake 9 | Pressed Soybean Cake | 30 | 276.8 | 136 | 5.5 | |
| Solvent | Solvent Extracted | 20 | 258.8 | 126 | 4.7 | |
| Extraction 1 | Soybean Meal | | | | | |

The pH adjusted slurry was loaded into pressure tubes and placed into an autoclave according to the desired condition parameters. Once pressure tubes cooled down, the hydrolysate was combined, and pH adjusted to a target 5.0.

Hydrolysate was then weighed out into baffled shaker flasks (300 g target) and dosed with 916 μL cellulase. The flasks were then placed into the shaker for 48 hours at 57.2° C. with and oscillation of 120 rpm.

At the completion of the 48 hours flasks, some material from one flask from the condition was filtered for HPLC analysis of the End of Saccharification sugar profile (EOS). The flasks were then all cooled to approximately 32° C. prior to adding 2 mL of yeast.

The shaker contents were adjusted to 32.2° C. with an oscillation of 100 rpm. Flasks fermented at these parameters for 24 hours. Following completion, some material from all flasks were filtered for HPLC sugar profiles and ethanol concentrations and the flasks were then combined for a condition composite for all further testing; during the testing, this product is referred to as stillage.

The stillage composite was split into two samples for testing: one to remain as stillage for testing and one to be used for oil spins and pellet creation. The stillage had solids determination performed on it and some of the stillage was put onto sheet pans for a slow dry.

The second stillage sample is placed into an Erlenmeyer to be cooked in a water bath heated to 87.8° C. for 1 hour with agitation. Stillage was then distributed in 50 mL spin tubes and placed in a centrifuge for 10 mins at 3500 rpm. Photos were taken of all conditions for the free oil content determination. Spin tubes were then poured off and drained at an angle for a couple minutes. Tubes were then sawed in half to allow the pellet to be obtained without free oil contamination. Pellets from all the tubes were combined and a portion was placed on a sheet pan for drying and the other portion was used for solids determination.

After both the stillage and pellet were dry to the touch, the pans were then scraped, and the material was ground down to <0.2 μm. Crude fat determination was done with a hexane solvent extraction, crude protein analysis was done with the use of a nitrogen analyzer.

The oil (fat) obtained from the process, at the various conditions, was analyzed and the results are shown in Table 2, below.

TABLE 2
Various properties of the oil (fat) samples
using the conditions shown in Table 1.

| | | Solids | Calculated Fat |
|---|---|---|---|
| | | “As Is” | at dry basis |
| Condition # | Sample | (% wt) | solids(% wt) |
| | Soybean | 94.1% | 22.3% |
| 1 | FAIL | FAIL | FAIL |
| 1 | FAIL | FAIL | FAIL |
| 2 | Stillage | 21.5% | 20.9% |
| 2 | Pellet | 24.3% | 20.9% |
| 3 | Stillage | 20.6% | 22.8% |
| 3 | Pellet | 29.7% | 20.5% |
| 4 | Stillage | 20.4% | 23.3% |
| 4 | Pellet | 29.7% | 23.0% |
| 5 | Stillage | 20.6% | 22.9% |
| 5 | Pellet | 31.9% | 18.2% |
| 6 | Stillage | 21.8% | 23.0% |
| 6 | Pellet | 31.3% | 20.8% |
| 7 | Stillage | 22.0% | 21.2% |
| 7 | Pellet | 29.5% | 22.9% |
| 8 | Stillage | 20.9% | 20.9% |
| 8 | Pellet | 31.7% | 21.4% |
| 8 | Pellet (remake) | 32.5% | 17.3% |
| 9 | Stillage | 19.9% | 20.8% |
| 9 | Pellet | 29.6% | 24.6% |
| 10 | Stillage | 20.9% | 23.4% |
| 10 | Pellet | 30.5% | 19.3% |
| 11 | Stillage | 21.8% | 21.1% |
| 11 | Pellet | 29.9% | 22.3% |
| 12 | FAIL | FAIL | FAIL |
| 12 | FAIL | FAIL | FAIL |
| Expeller 4 | Stillage | 19.4% | 10.7% |
| Expeller 4 | Pellet | 33.9% | 6.2% |
| Expeller 8 | Stillage | 21.2% | 9.6% |
| Expeller 8 | Pellet | 32.9% | 5.6% |
| Press Cake 1 | Stillage | 8.8% | 4.7% |
| Press Cake 1 | Pellet | 20.0% | 4.2% |
| Press Cake 2 | Stillage | 8.1% | 5.3% |
| Press Cake 2 | Pellet | 22.8% | 2.5% |
| Press Cake 3 | Stillage | 10.3% | 5.5% |
| Press Cake 3 | Pellet | 29.3% | 4.6% |
| Press Cake 4 | Stillage | 10.2% | 3.6% |
| Press Cake 4 | Pellet | 30.2% | 4.6% |
| Press Cake 5 | Stillage | 8.2% | 6.2% |
| Press Cake 5 | Pellet | 29.6% | 4.1% |
| Press Cake 6 | Stillage | 7.8% | 5.2% |
| Press Cake 6 | Pellet | 21.8% | 3.4% |
| Press Cake 7 | Stillage | 7.4% | 5.4% |
| Press Cake 7 | Pellet | 24.6% | 3.1% |
| Press Cake 8 | Stillage | 9.9% | 6.0% |
| Press Cake 8 | Pellet | 23.5% | 5.2% |
| Press Cake 9 | Stillage | 8.5% | 4.6% |
| Press Cake 9 | Pellet | 25.1% | 5.2% |
| Solvent Extraction 1 | Stillage | 14.0% | Not Available |
| Solvent Extraction 1 | Pellet | Not Available | Not Available |

From the data in Table 2, it is observed that pretreatment conditions may determine the amount of fat leftover after processing. Additionally, from the data in Table 2, it is observed that processing with an oil pressing step (expeller) prior to pretreatment resulted in lower fat content (more oil recovered).

The protein feed obtained from the process, at the various conditions, was analyzed and the results are shown in Table 3, below.

TABLE 3
Various properties of the protein samples
using the conditions shown in Table 1.

| | | Solids | Calculated Protein |
|---|---|---|---|
| Condition # | Sample | “As Is” (% wt) | at dry basis solids (% wt) |
| | Soybean | 94.1% | 40.2% |
| 1 | FAIL | FAIL | FAIL |
| 1 | FAIL | FAIL | FAIL |
| 2 | Stillage | 21.5% | 45.0% |
| 2 | Pellet | 24.3% | 47.7% |
| 3 | Stillage | 20.6% | 50.2% |
| 3 | Pellet | 29.7% | 57.7% |
| 4 | Stillage | 20.4% | 48.5% |
| 4 | Pellet | 29.7% | 59.3% |
| 5 | Stillage | 20.6% | 48.2% |
| 5 | Pellet | 31.9% | 60.2% |
| 6 | Stillage | 21.8% | 51.7% |
| 6 | Pellet | 31.3% | 63.3% |
| 7 | Stillage | 22.0% | 45.0% |
| 7 | Pellet | 29.5% | 48.7% |
| 8 | Stillage | 20.9% | 50.8% |
| 8 | Pellet | 31.7% | 56.9% |
| 9 | Stillage | 19.9% | 48.0% |
| 9 | Pellet | 29.6% | 61.6% |
| 10 | Stillage | 20.9% | 49.8% |
| 10 | Pellet | 30.5% | 59.9% |
| 11 | Stillage | 21.8% | 45.4% |
| 11 | Pellet | 29.9% | 47.3% |
| 12 | FAIL | FAIL | FAIL |
| 12 | FAIL | FAIL | FAIL |
| Expeller 4 | Stillage | 19.4% | 54.2% |
| Expeller 4 | Pellet | 33.9% | 69.6% |
| Expeller 8 | Stillage | 21.2% | 58.7% |
| Expeller 8 | Pellet | 32.9% | 68.1% |
| Press Cake 1 | Stillage | 8.8% | 63.1% |
| Press Cake 1 | Pellet | 20.0% | 64.8% |
| Press Cake 2 | Stillage | 8.1% | 60.5% |
| Press Cake 2 | Pellet | 22.8% | 61.6% |
| Press Cake 3 | Stillage | 10.3% | 60.0% |
| Press Cake 3 | Pellet | 29.3% | 71.0% |
| Press Cake 4 | Stillage | 10.2% | 59.4% |
| Press Cake 4 | Pellet | 30.2% | 74.5% |
| Press Cake 5 | Stillage | 8.2% | 60.3% |
| Press Cake 5 | Pellet | 29.6% | 73.7% |
| Press Cake 6 | Stillage | 7.8% | 62.2% |
| Press Cake 6 | Pellet | 21.8% | 66.1% |
| Press Cake 7 | Stillage | 7.4% | 60.4% |
| Press Cake 7 | Pellet | 24.6% | 62.1% |
| Press Cake 8 | Stillage | 9.9% | 60.6% |
| Press Cake 8 | Pellet | 23.5% | 69.3% |
| Press Cake 9 | Stillage | 8.5% | 62.8% |
| Press Cake 9 | Pellet | 25.1% | 74.9% |
| Solvent | Stillage | 14.0% | 64.5% |
| Extraction 1 | | | |
| Solvent | Pellet | Not Available | 76.9% |
| Extraction 1 | | | |

From the data in Table 3, it is observed that Pretreatment conditions determine the amount of protein leftover after processing. Additionally, from the data in Table 2, it is observed that the protein content of feed product can be increased meaningfully by removing fat and converting carbohydrates to ethanol.

The ethanol obtained from the process, at the various conditions, was analyzed and the results are shown in Table 4, below.

TABLE 4
Various properties of the ethanol samples
using the conditions shown in Table 1.

| Condition # | Sample | Ethanol (% wt/vol) |
|---|---|---|
| 1 | FAIL | FAIL |
| 2 | Beer | 1.8% |
| 3 | Beer | 2.3% |
| 4 | Beer | 2.0% |
| 5 | Beer | 2.1% |
| 6 | Beer | 2.1% |
| 7 | Beer | 1.9% |
| 8 | Beer | 2.0% |
| 9 | Beer | 2.1% |
| 10 | Beer | 2.2% |
| 11 | Beer | 1.9% |
| 12 | FAIL | FAIL |
| Expeller 4 | Beer | 2.2% |
| Expeller 8 | Beer | 2.3% |

From the data shown in Table 4, it is observed that carbohydrates can be converted to ethanol by utilizing pretreatment, enzymatic hydrolysis, and yeast fermentation.

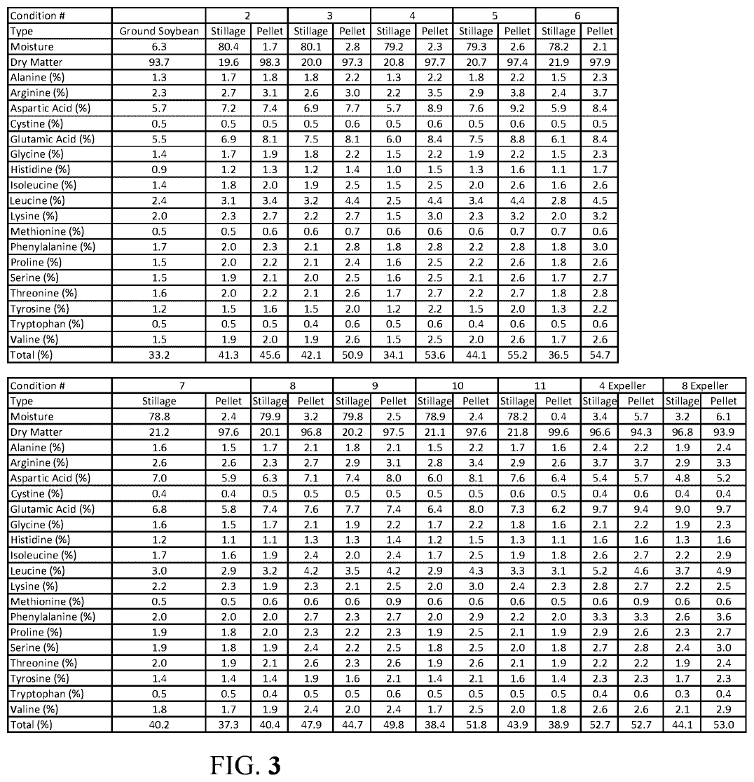

FIG. 3 shows amino acid analysis of the protein feed samples for the various conditions shown in Table 1. The results shown in FIG. 3 are reported on a dry matter basis. From the data shown in FIG. 3, it is observed that the feed product amino acid profiles can be optimized for desired components by adjusting pretreatment conditions.

The invention claimed is:

1. A method for processing soybean material, the method comprising:
receiving feedstock comprising either (i) raw whole soybeans and/or roasted soybeans, or (ii) soybean meal;
when the feedstock comprises (i), reducing a size of the feedstock via pressing, hammermilling or roller-milling thereby generating processed soybeans;
when the feedstock comprises more than 12 wt % oil dry basis, removing a portion of a raw bean oil from the processed soybeans to generate soybean material;
mixing the soybean material or the soybean meal with water, recycled water, or stillage to generate a slurry;
heating and adjusting a pH of the slurry to be acidic, thereby generating a heated slurry;
cooking the heated slurry at a temperature between 220° F. and 280° F., thereby generating a cooked slurry;
cooling and adjusting a pH of the cooked slurry;
adding an enzyme to the cooked slurry to initiate enzymatic hydrolysis and saccharification, thereby generating a soybean mash;
fermenting the soybean mash with yeast capable of utilizing C5 and C6 sugars to generate a soybean beer comprising ethanol;
removing ethanol from the soybean beer in an ethanol recovery unit;
collecting a high protein stillage from the ethanol recovery unit;
removing soybean oil from the high protein stillage, thereby generating de-oiled high protein stillage; and
concentrating the de-oiled high protein stillage.

2. The method according to claim 1, wherein the de-oiled high protein stillage has a protein content between 50 weight percent (wt. %) and 80 wt. % on a dry matter basis.

3. The method according to claim 1, wherein concentrating the de-oiled high protein stillage comprises at least one operation from the group consisting of:
centrifuging to separate materials and concentrate solids;
screening the concentrated de-oiled high protein stillage;
evaporating the concentrated de-oiled high protein stillage; and
drying the concentrated de-oiled high-protein stillage to remove excess moisture.

4. The method according to claim 1, wherein the ethanol is at least 180 proof.

5. The method according to claim 1, wherein the processed soybeans have a size such that at least 70% by volume of particles in the processed soybeans pass through a No. 12 sieve.

6. The method according to claim 1, wherein cooking the heated slurry is performed for a time period between 5 minutes and 60 minutes.

7. The method according to claim 6, wherein cooking the slurry is performed at a pressure between 18 psia and 50 psia.

8. The method according to claim 1, wherein heating the slurry comprises heating to a temperature between 175° F. and 212° F.

9. The method according to claim 1, wherein the heated slurry has a total solids content between 10 wt % and 30 wt %.

10. The method according to claim 1, wherein cooling the cooked slurry comprises flash cooling to a temperature between 150° F. and 212° F.

11. The method according to claim 10, wherein cooling the cooked slurry further comprises trim cooling to a temperature between 130° F. to 175° F.

12. The method according to claim 1, wherein adjusting the pH of the slurry comprises adding acid material such that the pH of the slurry is between 2.5 and 6.0.

13. The method according to claim 1, wherein adjusting the pH of the cooked slurry comprises adding basic material such that the pH of the slurry is between 4.0 and 6.0.

14. The method according to claim 1, wherein the enzyme comprises cellulase, hemicellulase, pectinase, glucoamylase, and combinations thereof.

15. The method according to claim 1, wherein yeast is added to the soybean mash in an amount between 0.0063% to 0.0188% dry yeast weight/fermented dry solids weight.

16. The method according to claim 15, further comprising propagating the yeast before fermenting, and adding the propagated yeast to the soybean mash.

17. The method according to claim 1, wherein enzymatic hydrolysis occurs for a time period between 20 hours and 48 hours before fermenting.

18. The method according to claim 1, wherein removing ethanol comprises distillation.

19. A system for processing soybean material, the system comprising:
a size reduction unit in communication with a soybean storage unit, the size reduction unit configured to receive feedstock from the soybean storage unit and reduce a particle size of the feedstock and generate soybean meal;
a slurry mix tank configured to receive the soybean meal and a liquid media and generate a slurry, the slurry mix tank comprising heating components configured to heat contents of the slurry mix tank to a temperature between 175° F. and 212° F.;
a reactor unit in communication with the slurry mix tank and configured to heat contents of the reactor unit to a temperature between 220° F. and 280° F. and pressurize to a pressure between 18 psia and 50 psia;
a cooling unit in communication with the reactor unit and configured to reduce the pressure and temperature of reacted material received from the reactor unit;
a hydrolysis mixing tank configured to receive cooled material from the cooling unit, pH adjustment material, and enzymatic material;
a fermentation tank in communication with the hydrolysis mixing tank, the fermentation tank configured to receive yeast;
an ethanol recovery unit in communication with the fermentation tank, the ethanol recovery unit comprising components configured to separate ethanol from soybean beer generated in the fermentation tank;
a separation unit configured to receive stillage from the ethanol recovery unit, the separation unit configured to separate oil from the stillage;
a dryer unit in communication with a retentate stream from the separation unit, the dryer unit configured to dry the retentate and generate solid protein material;
an evaporation unit in communication with a filtrate stream from the separation unit, the evaporation unit configured to generate a concentrated liquid; and
an oil recovery unit configured to receive the concentrated liquid from the evaporation unit, the oil recovery unit configured to separate oil from other constituents in the concentrated liquid.

20. The system according to claim 19, further comprising:
oil removal unit configured to remove oil from the feedstock and provide de-oiled feedstock to the slurry tank;
a direct inject steam unit in fluid communication with the slurry mix tank and configured to provide heated slurry to the reactor unit; and
a beerwell tank in communication with the fermentation tank and configured to provide soybean beer to the ethanol recovery unit,
wherein the cooling unit comprises a flash cooling unit in communication with the reactor unit and a trim cooling unit in communication with the flash cooling unit and the hydrolysis mixing tank.
